(19) United States
(12) Patent Application Publication
(10) Pub. No.: US 2006/0082090 A1
(43) Pub. Date: Apr. 20, 2006

(54) Steering wheel sensitivity brake control

(76) Inventor: Alain Constans, Terrebonne (CA)

Correspondence Address: BIRCH STEWART KOLASCH & BIRCH, PO BOX 747, FALLS CHURCH, VA, 22040-0747, US

(21) Appl. No.: 11/295,745

(22) Filed: Dec. 7, 2005

Related U.S. Application Data
(63) Continuation of application No. 10/220,848, filed on Mar. 11, 2003, now abandoned.

(30) Foreign Application Priority Data
Mar. 6, 2000 (CA) 2,299,669

(51) Int. Cl. B62B 5/04

(52) U.S. Cl. 280/88

(57) ABSTRACT

An apparatus for controlling the braking of a vehicle having a brake system. The apparatus comprises a brake actuating member (10) mounted to the vehicle within hand reach of a driver. Strain gages (17S, 18S) are adapted for being disposed in communication with the brake actuating member (10). A processing unit is connected to the strain gages (17S, 18S) for receiving input therefrom and for proportionally power-assisting the brake system of the vehicle, whereby the driver, by exerting varying pressure (A) by hand on the brake actuating member (10), controls the braking of the vehicle.

### CROSS-REFERENCE TO RELATED APPLICATIONS

This application is a Continuation of co-pending application Ser. No. 10/220,848 filed on Nov. 6, 2002, and for which priority is claimed under 35 U.S.C. § 120, which claims priority under 35 U.S.C. § 120 to International Application No. PCT/CA01/00279 filed Mar. 5, 2001, the entire contents of all are hereby incorporated by reference.

### BACKGROUND OF THE INVENTION

1. Field of the Invention

The present invention relates to brake systems and, more particularly, to the adaptation of sensors thereto for accelerating the actuating thereof.

2. Description of the Prior Art

In the world of automotive industry, the brakes are controlled by means of a brake pedal which mechanically actuates a hydraulic or pneumatic master cylinder. This master cylinder converts the mechanical effort of a driver in hydraulic or pneumatic pressure, which will actuate receiving pistons disposed in the brake of each wheel.

The disadvantage of having a pedal as interface between the driver and the braking system is the time required for the driver to change pedals to initiate the braking. When driving at a stable speed, the driver regulates the velocity of the vehicle by modulating the position of the accelerator pedal with his right foot, the left foot being reserved for the actuating of the shifting to change the gears of the mechanical gear box, or else the left foot is not used if the vehicle is equipped with an automatic transmission.

Each time a driver is brought to stop his vehicle, he must carry out three operations before the vehicle actually reaches the braking phase. First, he must completely let go of the accelerator pedal. Second, he must change the position of his right foot to bring it in front of the brake pedal. Third, he must apply pressure on the brake pedal to supply the brakes with brake fluid for the actuating thereof. At that point, the vehicle reaches the braking phase. The time elapsed during the three first maneuvers represents a traveled distance during which the vehicle has not attained its braking phase. In case of emergency braking, the elapsed time may prove to be costly and may even endanger the life of the driver.

Different apparatuses have been provided to assist the known braking systems. For instance, there exists an electronic system of brake control which intervenes in case of wheel blocking. This system is referred to as Anti-Blocking System, i.e. ABS. The electronic system controls the brakes directly, during its intervention, but the interface of the driver is still the brake pedal.

Strain gauge sensors have been used in order accelerate the attainment of the braking phase of a vehicle. International Publication No. WO 99/41565, published Aug. 19, 1999 by Maubant and Rancourt, discloses a strain gauge sensor connected to internal mechanical amplification to be used to measure the deflection of a beam. In an embodiment, this sensor may be mounted on a brake pedal in order to establish the value of brake torque to be applied to the brakes.

As illustrated in FIG. 1 (representing the prior art), such a brake system is shown at S and comprises a brake pedal 1 at an end of a brake lever 3, which is pivotally mounted to the vehicle frame. A strain gauge sensor 2 is secured to the brake lever 3 in proximity of the coupling axis of the push rod 4 of a master cylinder (not shown), thereby defining a sensitivity brake pedal. The brake system S is actuated by a driver exerting varying pressure on the brake pedal 1 with his foot F in the directions shown by arrow A. The strain gauge sensor 2 measures in real time the deflection (or deformation) of the brake lever 3, which will help establish the control force exerted by the driver on the brake pedal 1. An electronic processing unit (not shown), to which the strain gauge sensor 2 is wired, receives the deformation input signal and interprets it to determine an electronic value of power assistance, which will be supplied in braking torque to each brake.

A first advantage of the above described apparatus resides in that the use of electrical signal to actuate the braking results in a gain of part of the time elapsed during the transmission of hydraulic or pneumatic pressure to brakes. This amount of time, although seemingly negligible, is valuable in the event of emergency braking, as the brakes react in real time as the driver touches the brake pedal 1.

Referring to FIG. 2 (also representing the prior art), a variation of the above described apparatus consists in placing strain gauge sensors 2 on the master cylinder 5, whose deformation, resulting from the internal pressure of brake fluid, is measured. As illustrated, the master cylinder 5 comprises a power booster 6, which is, however, compulsory in this embodiment. The master cylinder 5, when actuated by the braking pedal 1 in the direction shown at A, is subject to deformation which is picked up by the sensor 2 which will generate an electrical signal proportional to the fluid pressure in the master cylinder 5. This device allows for the securing of the strain gauge sensors 2 on an idle member, thereby providing advantages with regards to stability and repetition of the signal.

Although the use of strain gauge sensors has accelerated the braking time of vehicles, an important amount of time is lost in attaining the braking phase by having a pedal interface.

### SUMMARY OF THE INVENTION

It is therefore an aim of the present invention to provide an apparatus for accelerating the attainment of the braking phase by providing manual braking control.

Therefore, in accordance with the present invention, there is provided an apparatus for controlling the braking of a vehicle having a brake system, comprising a brake actuating member mounted to the vehicle within hand reach of a driver; sensor means adapted for being disposed in communication with the brake actuating member; processing means being connected to said sensor means for receiving input therefrom and for proportionally power-assisting the brake system of the vehicle; and whereby the driver, by exerting varying pressure by hand on the brake actuating member, controls the braking of the vehicle.

Also in accordance with the present invention, there is provided an apparatus for controlling the braking of a vehicle having a brake system, comprising sensor means adapted for being disposed on a portion of a steering column system for measuring deformation thereof; processing means being connected to said sensor means for receiving deformation input therefrom and for proportionally power-assisting the brake system of the vehicle; and whereby a driver, by exerting varying pressure by hand on said steering column system through a steering wheel, controls the braking of the vehicle.

Also in accordance with the present invention, there is provided an apparatus for controlling the braking of a vehicle having a brake system, and comprising at least a lever plate adjacent a rim of a steering wheel; sensor means adapted for being disposed on said lever plate for measuring deformation thereof; processing means being connected to said sensor means for receiving deformation input therefrom and for proportionally power-assisting the braking system of the vehicle; and whereby a driver, by exerting varying pressure on said lever plate by hand while holding said rim, controls the braking of the vehicle.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a schematic side elevational view illustrating a brake pedal with a strain gauge sensor of the prior art;

FIG. 2 is a schematic perspective view of a brake pedal and a master cylinder with strain gauge sensors on the master cylinder in accordance with the prior art;

FIG. 3a is a schematic side elevational view of a strain gauge sensor mounted on a steering wheel in accordance with the present invention;

FIG. 3b is a schematic front elevational view of the steering wheel of FIG. 3a;

FIG. 4 is a schematic side elevational view of the strain gauge sensors mounted on a housing of a steering column in accordance with the present invention;

FIG. 5a is a schematic top plan view of the strain gauge sensors mounted on lever plates in accordance with the present invention;

FIG. 5b is a schematic, fragmentary, side elevational segmented view of FIG. 5a;

FIG. 5c is a schematic perspective view of FIG. 5a; and

FIG. 6 is a schematic side elevational view of a lever plate having a strain gauge sensor mounted to a dashboard.

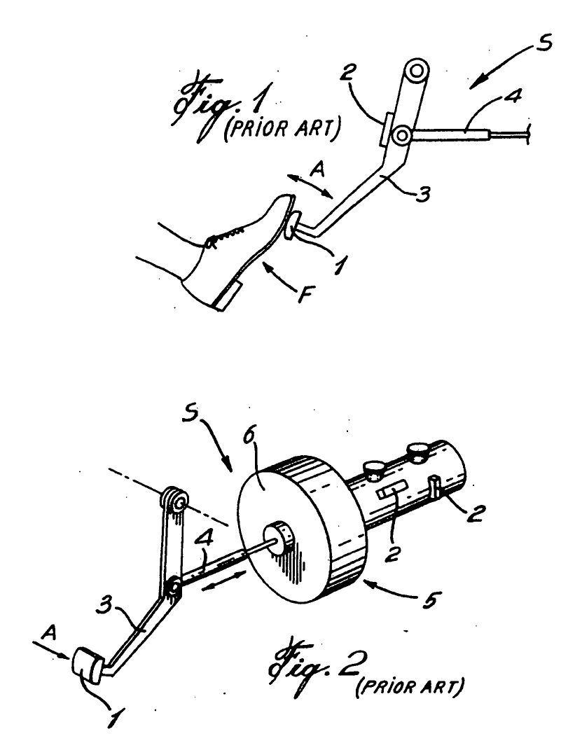

### DESCRIPTION OF THE PREFERRED EMBODIMENTS

Referring now to the drawings and, more particularly, to FIGS. 3a and 3b, a steering wheel is generally shown at 10. The steering wheel 10 is comprised of a rim 12 mounted to a steering column 14 by horizontal spokes 16 and 17 and a vertical spoke 18 converging at a hub portion 20. Strain gauge sensors 16S, 17S and 18S are secured to the horizontal spokes 16, 17 and the vertical spoke 18, respectively. When the driver exerts a push or a pull on the steering wheel 10 as shown by arrow A, the horizontal spokes 16 and 17 and the vertical spoke 18 are subject to deformation, which is picked up by the strain gauge sensors 16S, 17S and 18S. A signal is then sent to a processing unit 50 to which the strain gauge sensors 16S, 17S and 18S are wired. The processing unit 50 will immediately power-assist the brakes in outputting brake torque proportionally to the driver's input, whether it be through the master cylinder or directly to the brakes.

The advantage of the above described embodiment is that the driver does not lose time in displacing his right foot from the accelerator pedal to the brake pedal in the event of an emergency braking. It is also well known that for most people, the eye-hand reaction is more rapid than the eye-foot response. Thus an important gain is achieved on the braking system reaction time, which results in a decrease of the traveled distance by the vehicle between the instant of the braking decision and the effective supply of brake torque. Furthermore, a gain of time may be achieved in the processing of the braking information. In the prior art, the driver builds hydraulic pressure in the master cylinder by actuating the brake pedal, which pressure is transmitted via distribution lines to each brake. As explained above, the strain gauge sensors may be directly connected to each brake through the processing unit, whereby the braking command is outputted generally instantaneously to the brakes.

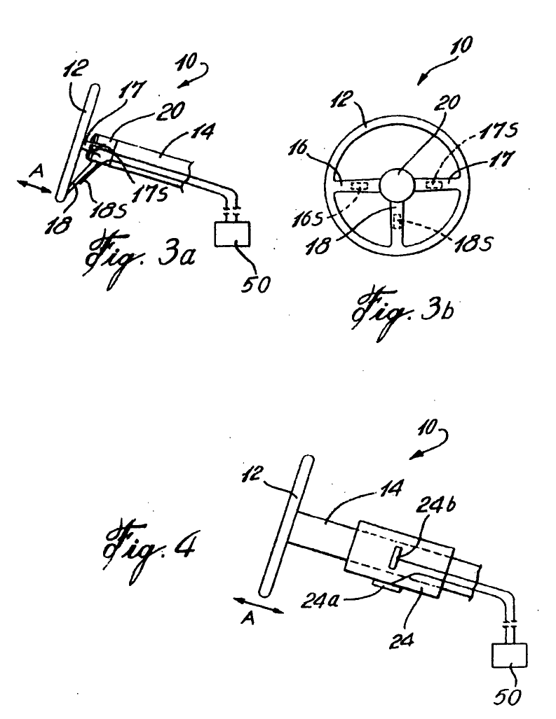

Referring now to FIG. 4, another embodiment of the present invention is illustrated and is also for controlling the brakes in response to pressure exerted on the steering wheel 10 by the driver. The steering column 14 is shown supported in a housing 24. Strain gauge sensors 24a and 24b are mounted to the housing 24 such as to measure the deformation of the steering column 14, in response to the driver's pressure in the A directions on the steering wheel 10. The sensor 24a, which measures the axial deformation, and the sensor 24b, which measures the radial deformation, are electrically connected to a processing unit 50. The advantage of this embodiment resides in the strain gauge sensors being idle as they are on the housing 24 of the steering column 14. This results in a simplified mounting of the strain gauge sensors as well as increased stability and repetition in signal delivery.

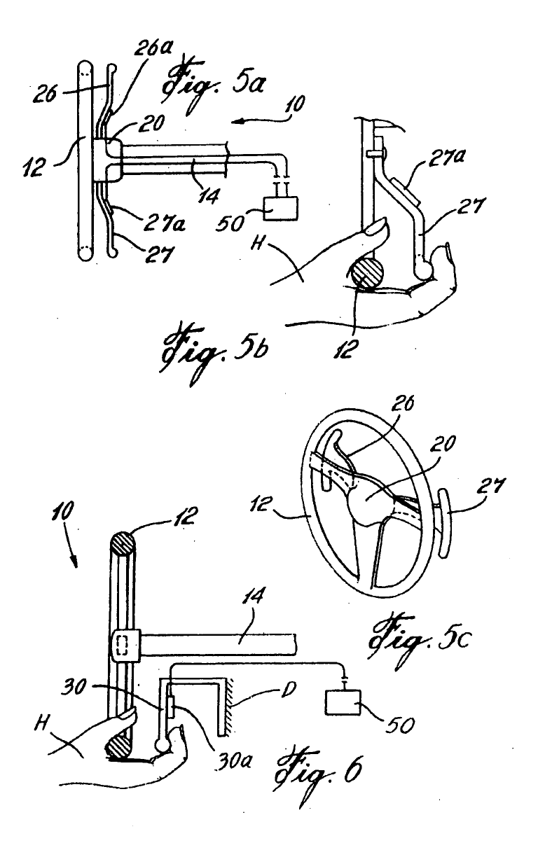

Referring now to FIGS. 5a, 5b and 5c, still another embodiment of the present invention is illustrated. A pair of opposed lever plates 26 and 27 are mounted to the hub portion 20 of the steering wheel 10. The lever plates 26 and 27 are placed on the steering wheel 10 to correspond with the positioning of the hands H of the driver. Strain gauge sensors 26a and 27a are mounted to the lever plates 26 and 27, respectively, and are electrically wired to a processing unit 50. As these lever plates 26 and 27 are mounted to the hub 20 of the steering wheel 10, they will rotate therewith. As best shown in FIG. 5b, the driver will squeeze the lever plate 27 and the rim 12 with his hand H to deflect the lever plate 27. As explained previously, the deformation is picked up by the strain gauge sensor 27a, which will generate braking torque through the processing unit. It is observed that the driver may keep steering the vehicle while braking.

Referring now to FIG. 6, a still further embodiment of the present invention is depicted. In this case, a lever plate 30 is mounted to the dashboard D of the vehicle. A strain gauge sensor 30a is secured on the lever plate 30 and is electrically wired to the processing unit 50. By squeezing the rim 12 and the lever plate 30 with hand H, the braking will be actuated.

It is noted that the embodiments described in FIGS. 3a and 3b, FIG. 4, FIGS. 5a, 5b and 5c and FIG. 6 may be used to achieve a directional braking control by picking up vectorial information from each respective strain gauge sensor. In such a case, the braking control signal outputted to the brakes is no longer the same value for each brake as it becomes differential. For instance, a greater force applied on the lever plate 26 with respect to the lever plate 27 of FIG. 5a may be translated into a greater braking torque applied to the brakes of the left side of the vehicle. This differential braking torque will allow the modification of the trajectory of the vehicle towards the left or the right.

I claim:

1. An apparatus for braking a vehicle having a brake system and a steering system including a steering column and a steering wheel connected thereto, the apparatus comprising:
at least one brake actuating lever dedicated solely to actuation of said brake system, said brake actuating lever being spaced from said steering wheel and mounted therebehind within hand reach of a driver of the vehicle, said brake actuating lever being deflectable in response to pressure exerted thereon by said driver; and
at least one sensor disposed in communication with said brake actuating lever.

2. The apparatus as defined in claim 1, wherein said brake actuating lever is substantially parallel to a plane of said steering wheel and is deflectable in response to pressure exerted thereon in a direction which intersects said plane.

3. The apparatus as defined in claim 2, wherein said brake actuating lever is deflectable in response to pressure exerted thereon in a direction substantially normal to said plane of said steering wheel.

4. The apparatus as defined in claim 1, wherein said brake actuating lever is secured to a portion of said steering wheel, such that the brake actuating lever turns with said steering wheel allowing the driver to turn the steering wheel while controlling braking of the vehicle with said brake actuating lever.

5. The apparatus as defined in claim 4, wherein said brake actuating lever is secured to a hub portion of said steering wheel.

6. The apparatus as defined in claim 1, wherein said brake actuating lever is secured to a dashboard of the vehicle.

7. The apparatus as defined in claim 1, wherein said at least one sensor includes a strain gauge.

8. A braking actuation system adapted for use for use with a brake system to brake a vehicle having a steering system including a steering column and a steering wheel connected thereto, the braking actuation system comprising:
a brake actuating member dedicated solely to actuation of said brake system, said brake actuating member being mounted to the vehicle within hand reach of a driver thereof, said brake actuating member being deflectable in response to pressure exerted thereon by a hand of the driver in a direction which intersects a plane of said steering wheel; and
at least one sensor disposed in communication with said brake actuating member, said sensor being operable to measure deformation of said brake actuating member when said pressure is exerted thereon by the driver.

9. The braking actuation system as defined in claim 8, wherein said brake actuating member is deflectable in response to pressure exerted thereon in a direction substantially normal to said plane of said steering wheel.

10. The braking actuation system as defined in claim 8, wherein said at least one sensor includes a strain gauge.

11. The braking actuation system as defined in claim 8, wherein said at least one sensor is disposed on said brake actuating member.

12. The braking actuation system as defined in claim 8, wherein said brake actuating member includes at least one lever spaced from said steering wheel and mounted therebehind within hand reach of the driver.

13. The braking actuation system as defined in claim 12, wherein said at least one sensor includes a strain gauge disposed on said lever.

14. The braking actuation system as defined in claim 13, wherein said brake actuating member is mounted to one of said steering wheel and a dashboard of the vehicle.

15. An apparatus for controlling the braking of a vehicle having a brake system and a steering system including a steering column and a steering wheel connected thereto, the apparatus comprising: a brake actuating portion of said steering system, said brake actuating portion being disposed within hand reach of a driver and operable to actuate said brake system; and a strain gauge sensor disposed on the brake actuating portion for measuring deformation thereof; whereby the driver, by exerting pressure by hand on the steering system, controls the braking of the vehicle.

16. The apparatus as defined in claim 15, wherein said steering wheel of said steering system includes a rim and at least one spoke, said spoke defining said brake actuating portion.

17. The apparatus as defined in claim 15, wherein said brake actuating portion includes a steering column housing within which said steering column of said steering system is free to rotate, said strain gauge sensor being disposed on said steering column housing.

18. The apparatus as defined in claim 15, wherein said strain gauge sensor measures at least one of axial and radial deformation of the brake actuating member.
